(19) United States
(12) Patent Application Publication
(10) Pub. No.: US 2015/0343353 A1
(43) Pub. Date: Dec. 3, 2015

(54) FILTER MATERIAL, IN PARTICULAR FOR HYDRAULIC FILTERS

(71) Applicant: HYDAC FILTERTECHNIK GMBH, Sulzbach/Saar (DE)

(72) Inventors: Matthias SCHWENDER, Kirkel (DE); Andreas SCHMITZ, Kirkel (DE); Stefan JOCHUM, Huettigweiler (DE); Edwin KOCH, Tholey (DE)

(21) Appl. No.: 14/652,543

(22) PCT Filed: Jan. 16, 2014
(86) PCT No.: PCT/EP2014/000096

§ 371 Date: Jun. 16, 2015

(30) Foreign Application Priority Data
Jan. 19, 2013 (DE) 10 2013 000 934.0

(51) Int. Cl. B01D 39/08

(52) U.S. Cl. CPC B01D 39/08

(57) ABSTRACT

A filter material, in particular for hydraulic filters, comprises at least one filter layer (18, 20, 22, 24), each individual filter fold (12) thereof being composed of a pair of filter bid halves (13), consists of a first structure (32) having warp threads (34) and weft threads (36), and of at least one further second structure (20, 22) with a predeterminable filtering characteristic, and is characterized in that the structures are designed such and are operatively connected to one another such that at least one channel guide (40) is formed in the filter layer (15, 20, 22, 24) in particular as a result of the arrangement and geometry of the warp threads (34) and well threads (36) of the first structure (32), said channel guide allowing an undisturbed flow through the respective filter fold half (13) over substantially the entire fold height.

The invention relates to a filter material, provided in particular for hydraulic filters, having at least one filter layer, the individual filter folds of which are composed in each ease of a pair of filter fold halves, comprising a first structure, having warp threads and weft threads, and at least one further, second structure having a predefinable filtration characteristic.

Filter materials for manufacturing exchangeable filter elements in hydraulic systems are known in a variety of designs. These types of filter materials, in pleated or folded forms, having filter folds made of adjacent filter fold halves, are composed, for example, of one, or preferably numerous, layers made of a nonwoven filter medium, as a structure having a filtration characteristic, and of at least one structure in the form of a support layer on one or both sides thereof (inflow or outflow side). The structures forming the support layer, in the form of meshes having warp and weft threads, have the task of stabilizing the filter material. When the fluid flows through the filter material there are considerable pressure differences, in part, between the raw side and the clean side. In order to be able to maintain these pressure differences, as well as dynamic flow forces in the unfiltered product, known supporting structures are usually formed from metal meshes, in particular meshes made of stainless steel wires. Although such structures enable a good protection against loads due to pressure changes that arise during the operation of the filter element, the advantage of a greater mechanical stability, however, is offset by a decrease in fluid permeability of the filter material. if greater mesh sizes are provided in the meshes of such supporting structures, in order to obtain lower flow resistances, there is then the disadvantage, in turn, of a lower resistance against loads due to pressure changes during operation.

With regard to this problem, the invention addresses the object of providing a filter material, which ensures a high fluid permeability, despite good structural stability.

According to the invention, this object is achieved with a filter material having the features of Claim 1 in its entirety.

According to the characterizing portion of Claim 1, a substantial feature of the invention lies in that the structures are designed such and are operatively connected to one another such that at least one channel guide is formed, in particular by the configuration and geometry of the warp and weft threads of the first structure inside the filter layer, which channel guide enables an unimpeded flow through the respective filter fold half over, substantially, the entire fold height. Without needing to provide large mesh sizes for a respective supporting structure, and as a result having to forfeit the mechanical stability, it is thus possible to obtain particularly low flow resistances.

Particularly favorable flow conditions can be obtained when the warp threads run transverse to the longitudinal extension, and the weft threads run in the longitudinal extension, of the respective filter halves.

A respective supporting structure can be designed, with particular advantage, such that at least a first portion of the respective weft threads borders on open channel cross-sections, or extends over the entire fold height of a filter fold half in the form of a continuous channel section, having two thread sections that run substantially parallel to one another.

The configuration can be achieved thereby, to particular advantage, such that at least a portion of the respective weft thread assumes a curved course, and is supported, toward both the interior and exterior, preferably by warp threads disposed in pairs.

A mesh of this type, serving as a supporting structure, can be optimized for a particularly good permeability, such that at least a portion of the respective weft threads, over or under which, in each case, a pair of adjacent warp threads passes at a spacing thereto, border on these warp threads with right triangle flow-through cross-sections in each case, through which fluid can flow in the direction parallel to the warp threads, wherein the hypotenuse of the triangular cross-section is oriented parallel to the welt thread direction between the pair of warp threads, and one of the two legs is formed by the warp thread of a pair over which the associated well thread passes.

Further advantageous designs and further developments of the filter material are specified in the dependent Claims 6 to 12.

The subject matter of the invention also includes a filter element, having a filter material in a design according to one of the Claims 1 to 12.

The invention shall be explained in greater detail below, based on exemplary embodiments depicted in the drawings.

Therein:

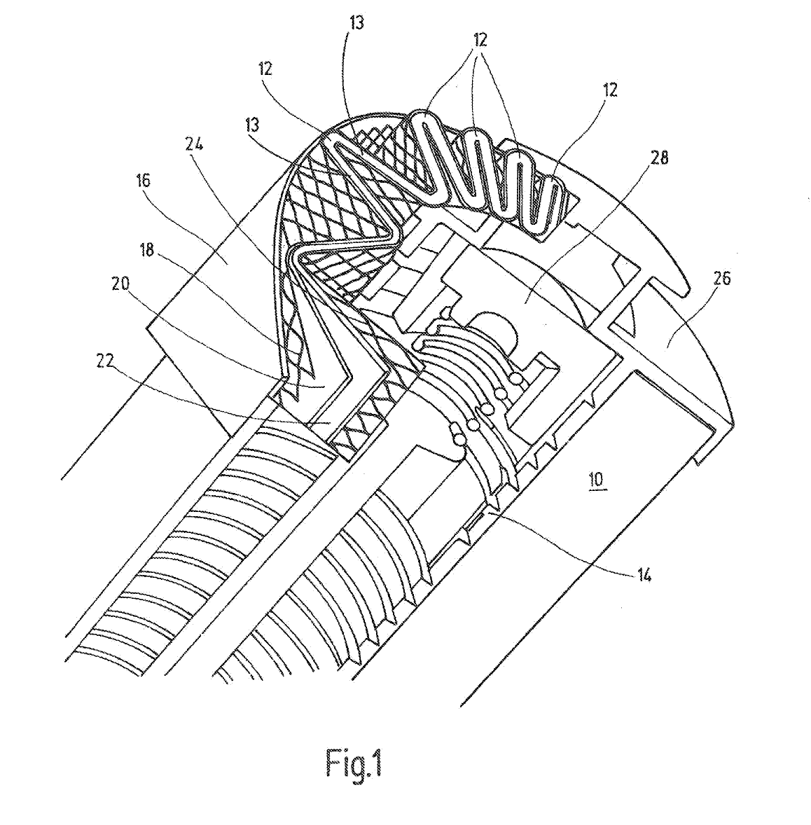

FIG. 1 shows, in a partially cut open, schematically simplified depiction, the upper portion of a filter element having a filter material according to the prior art;

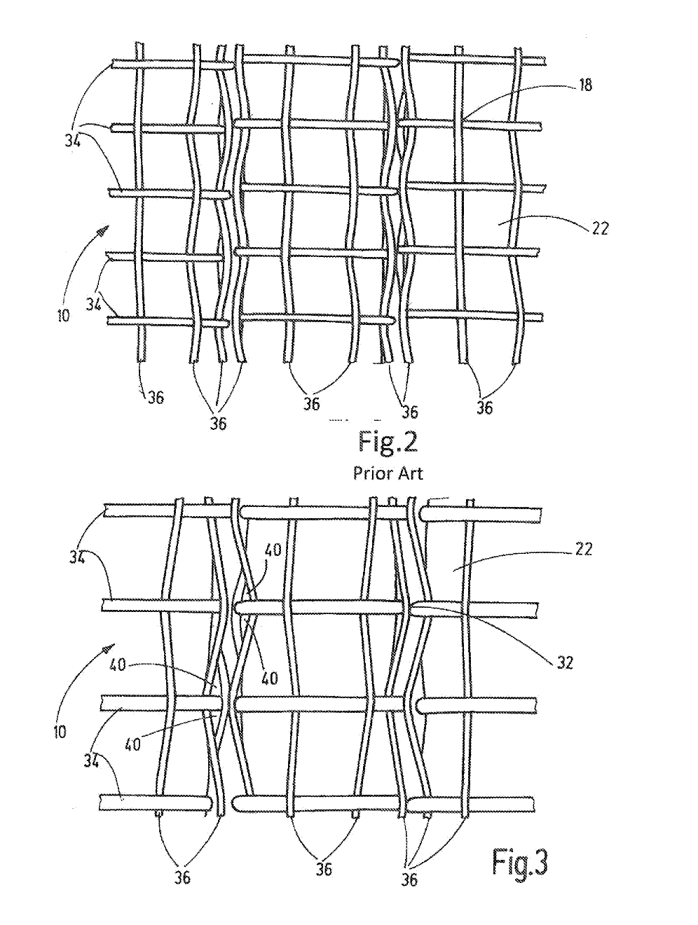

FIG. 2 shows an enlarged, perspective plan view of a section of a filter material according to the prior art;

FIG. 3 shows a plan view, similar to that in FIG. 2, of a filter material according to one exemplary embodiment of the invention;

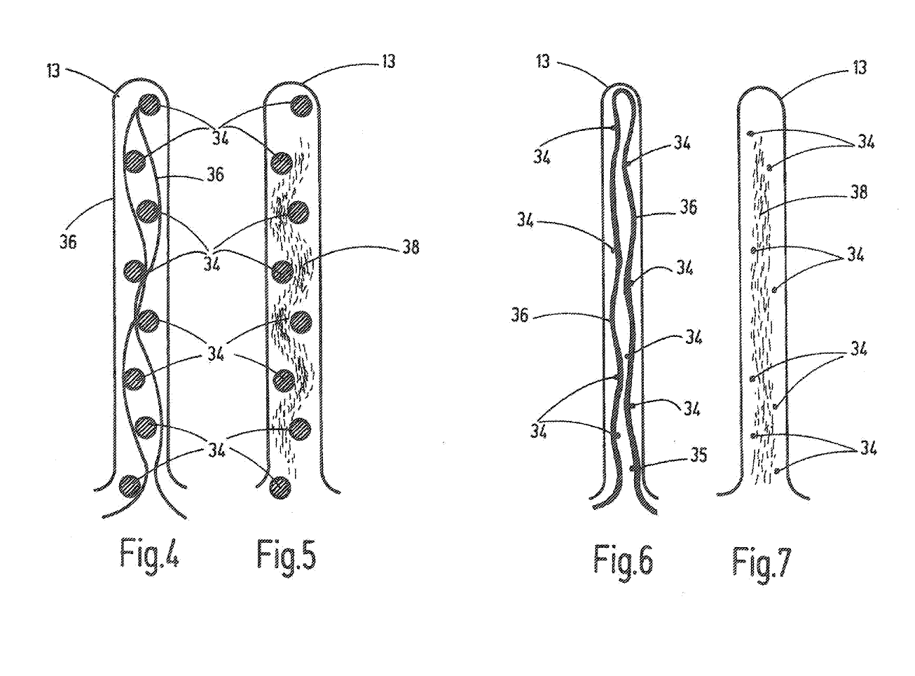

FIG. 4 shows an enlarged, highly schematically simplified sectional view of the supporting structure of a single filter fold half;

FIG. 5 shows a depiction, similar to that in FIG. 4, without the well threads indicated, wherein the flow pattern formed by the channel guides of the structure is indicated.

FIG. 6 shows a depiction, corresponding to that in FIG. 4, of another exemplary embodiment;

FIG. 7 shows a depiction, corresponding to that in FIG. 5, of the exemplary embodiment in FIG. 6;

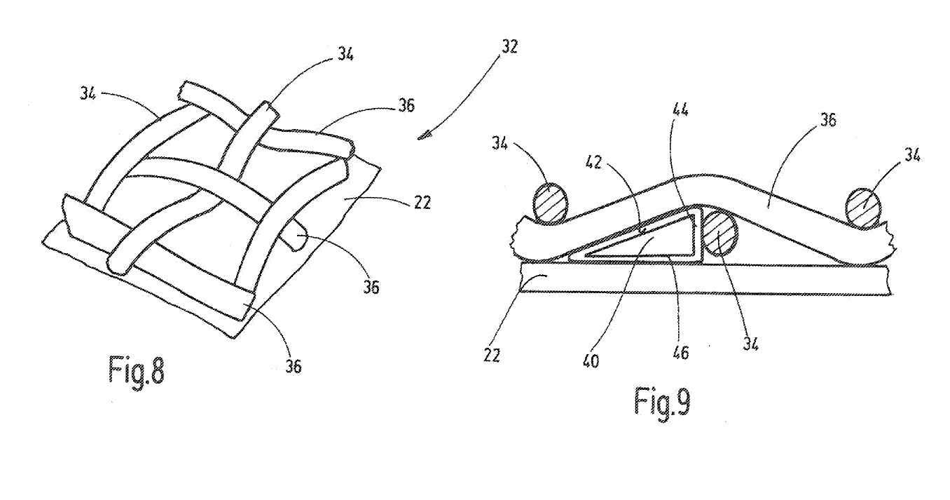

FIG. 8 shows a greatly enlarged section, in which only a few meshes of a supporting structure and a nonwoven layer forming a further structure are depicted, and

FIG. 9 shows a sub-section, enlarged to a greater extent than in FIG. 8, in which a triangular flow-through cross-section is indicated.

The filter element, partially depicted in FIG. 1, as it pertains to the prior art, has a filter mat 10 as the filter material, having a predefinable surface porosity and predefinable filtering characteristic. The filter mat 10 is pleated, as depicted in FIG. 1, having individual filter folds 12, which extend in a dense packing sequence between an internal fluid-permeable supporting tube 14 and between an external, cylindrical housing sheath 16, which is likewise permeable. For a better depiction, the individual filter folds 12, each of which is composed of one filter fold half 13 (only numbered in part in FIG. 1), are depicted in a partially pulled apart state, and the individual layer structure of the pleated filter mat 10 can be derived from the partial depiction facing the observer.

With filter elements constructed in this manner, the filter mat 10 is normally composed of a support layer 18 serving as a supporting structure, a second layer 20 as a protective nonwoven, a third layer 22 as a main nonwoven or filter layer, and optionally, a further layer, not shown, of a likewise adjoining protective nonwoven, and in any case, a fourth layer as a further support layer 24, running on the internal circumference, as a further supporting structure. The support layers 18, 24 referred to above can be composed of a wire mesh, a plastic grid, or a plastic mesh. One of these support layers 18, 24 serves as a drainage layer in addition to its supporting function. The protective nonwovens 20 are normally composed of a plastic nonwoven, and the main nonwoven layer, or filter layer 22 is composed of materials such as glass fiber paper, synthetic filter material (melt-blown fibers), cellulose paper, or the like, The layers referred to above can also be made from so-called composite materials of the same type, or of a different type. Depending on the layer structure and the respective filter material employed therein, the filter mat 10 has predefinable filtering characteristics, which are oriented to the filtration task, wherein, fundamentally, a high differential pressure stability is desired, as well as a high beta-stability over a broad pressure difference range, and also predefinable filtering subtleties, wherein sufficient flow channels should be provided, in order to reduce the differential pressure at the filter element, while at the same time, however, a good resistance to changing pressure loads should be ensured.

Seen from the perspective of Fig. I, with the known filter element, fluid flows through the filter mat 10 from the exterior to the interior, and the filter element rests, at its relevant folds on its internal circumference, against the external circumference of the support tube 14, on the annular outlets thereof. The ends of the filter mat are each accommodated in an end cap, wherein only the upper end cap 26 is depicted in FIG. 1, which furthermore comprises a spring-loaded bypass valve 28, which enables the passage of fluid for safety reasons, even when the filter mat 10 is clogged with contaminants.

FIG. 2 shows a plan view of a filter material in the form of a filter mat 10 according to the prior art, having a standard structure as the support layer 18, which is formed by a metallic grid. A grid of this type serves as a drainage layer, optionally with a further, internal support layer 24, which is not visible in FIG. 2, in order to create flow channels for the through-flow of the fluid.

FIG. 3 shows an exemplary embodiment of the filter material according to the invention, having a supporting structure 32, in the term of a mesh made of warp threads 34 and weft threads 36, lying against the main nonwoven layer, or filter layer 22. The weft threads 36, which have a smaller diameter than the warp threads 34, run in the direction of the longitudinal extension of the respective filter fold half 13, substantially over the entire height of the fold, while the warp threads 34 run transverse to the fold height, see FIG. 4 in which a single filter fold half 13 is depicted schematically, and only in the manner of a sketching. The mesh formed by the warp and well threads 34, 36 in the manner of a plain weave is designed such that, in order to optimize the permeability, open channel cross-sections are bordered by the weft threads 36, which cross-sections extend over the entire fold heights of the respective filter fold halves 13 in the form of continuous channel sections along thread sections of the well threads 36 running parallel to one another. As is shown in FIG. 4, at least a portion of the respective weft threads 36 is supported, in its curved course running inward and outward, by warp threads 34 disposed in pairs. The flow pattern indicated by a broken line 38 in FIG. 5 is obtained with this design of the mesh.

The exemplary embodiment in FIGS. 6 and 7 differs from that in FIGS. 4 and 5 in that, with otherwise identically structured meshes, the weft threads 36 have a greater diameter than the warp threads 34. Channel guides are formed, in turn, over the entire height of the filter fold halves 13 for the flow pattern indicated by the numeral 38. The warp threads 34 and weft threads 36 can be made of plastic or metal. The plastic threads can be advantageously formed from polybutylene terephthalate, polypropylene or polyester. Stainless steel can be provided as the metallic material.

For optimal flow conditions, the mesh can be specially designed, as illustrated in FIGS. 8 and 9. As is indicated in FIG. 9 by a triangle 40, a flow-through cross-section in the shape, of a right triangle 40 is formed, in each case, between the warp threads 34 and the weft threads 36 passing over or under respective warp threads, wherein a flow is possible through this flow-through cross-section in the direction parallel to the warp threads 34. The hypotenuse 42 of the triangle 40 runs parallel to the direction of the weft threads, and the smaller leg is formed by the relevant warp thread 34, over which the associated weft thread 36 passes. The longer leg 46 of the triangle extends along the adjoining main nonwoven layer, or filter layer 22. Some of the triangular cross-sections 40 formed thereby are also numbered, by way of example, in FIG. 3.

1. A filter material, in particular provided for hydraulic filters, having at least one filter layer (18, 20, 22, 24), the individual filter folds (12) of which are each composed of a pair of filter fold halves (13), comprising a first structure (32) having warp threads (34) and weft threads (36), and comprising at least one further, second structure (20, 22) having a predefinable filtration characteristic, characterized in that the structures are designed such and are operatively connected to one another such that, in particular by means of the configuration and geometry of the warp threads (34) and weft threads (36) of the first structure (32), at least one channel guide (40) is formed inside the filter layer (18, 20, 22, 24), which channel guide enables an unimpeded flow through the respective filter fold half (13) over substantially the entire fold height.

2. The filter material according to claim 1, characterized in that the warp threads (34) run transverse to the longitudinal extension of the respective filter fold half (13) and the weft threads (36) run in the longitudinal extension of the respective filter fold half (13).

3. The filter material according to claim 2, characterized in that at least a portion of the respective weft threads (36) borders open channel cross-sections (40), or extends over the entire fold height of a filter fold half (13) in the form of a continuous channel section having two thread sections (34) running substantially parallel to one another.

4. The filter material according to claim 1, characterized in that at least a portion of the respective weft threads (36) assumes a curved course, and is supported toward the interior and the exterior, preferably by warp threads (34) disposed in pairs.

5. The filter material according to claim 1, characterized in that at least a portion of the respective weft threads (36), over or under which, in each case, a pair of adjacent warp threads (34) passes at a spacing thereto, is bordered in each case by right triangle flow-through cross-sections (40), through which fluid can flow in directions parallel to the warp threads (34), and in that the hypotenuse (42) of the triangular cross-section (40) is oriented parallel to the direction of the weft thread (36), between the pair of warp threads (34), and one of the two legs (44) is formed by the warp thread (34) of a pair, over which the associated weft thread (36) passes.

6. The filter material according to claim 1, characterized in that the mesh of the respective supporting structure (32) is a plain weave.

7. The filter material according to claim 1, characterized in that the warp threads (34) and weft threads (36) are made of plastic.

8. The filter material according to claim 1, characterized in that the warp threads (34) and weft threads (36) are made of metal.

9. The filter material according to claim 1, characterized in that the diameter of the warp threads (34) is greater than the diameter of the weft threads (36).

10. The filter material according to claim 1, characterized in that the mesh size of the first structure (32) lies in the range of 1 mm to 2 mm.

11. The filter material according to claim 1, characterized in that the warp threads (34) have a diameter of 0.2 mm to 0.35 mm.

12. The filter material according to claim 1, characterized in that the weft threads (36) have a diameter of 0.1 mm to 0.26 mm.

13. A filter element having a filter material in a design according to claim 1.
